(19) United States
(12) Patent Application Publication
(10) Pub. No.: US 2015/0040129 A1
(43) Pub. Date: Feb. 5, 2015

(54) SYSTEM AND METHOD FOR VIRTUAL MACHINE PLACEMENT AND MANAGEMENT IN CLUSTER SYSTEM

(71) Applicant: Electronics and Telecommunications Research Institute, Daejeon (KR)

(72) Inventors: Choon Seo PARK, Daejeon (KR); Mi Young LEE, Daejeon (KR); Sung Jin HUR, Daejeon (KR)

(73) Assignee: Electronics and Telecommunications Research Institute, Daejeon (KR)

(21) Appl. No.: 14/079,234

(22) Filed: Nov. 13, 2013

(30) Foreign Application Priority Data
Aug. 5, 2013 (KR) 10-2013-0092741

(51) Int. Cl. G06F 9/455

(52) U.S. Cl. CPC G06F 9/45533
USPC 718/1

(57) ABSTRACT

A system for virtual machine placement and management monitors information regarding states of physical machines and virtual machines operated in a subgroup, and relocates the virtual machines operated in the subgroup according to information regarding states of the physical machines operated in the subgroup and a placement policy of the virtual machines.

### CROSS-REFERENCE TO RELATED APPLICATION

This application claims priority to and the benefit of Korean Patent Application No. 10-2013-0092741 filed in the Korean Intellectual Property Office on Aug. 5, 2013, the entire contents of which are incorporated herein by reference.

### BACKGROUND OF THE INVENTION

(a) Field of the Invention

The present invention relates to a system and method for virtual machine placement and management, and more particularly, to a technique of placing, operating, and managing a virtual machine (VM) in a cluster node system such as a cloud.

(b) Description of the Related Art

Recently, placement and management of virtual machines in a cluster system such as a cloud have come to prominence. In order to effectively configure a cluster system such as the cloud and stably support the same for users, functions of effectively placing and managing virtual machines are required. In particular, the necessity of selecting an appropriate physical machine (PM) in which a virtual machine is to be installed and effectively managing the same is on the rise.

Recently, studies on virtual machine placement methods have been conducted. As representative virtual machine placement methods, a power-based method and a QoS-based method have mainly been researched.

Currently, as cluster systems are increasing in size, electric power costs incurred to operate a cluster system and an issue of guaranteeing performance of a virtual machine to a user desired level are at issue.

Most existing power-based placement methods propose a way for reducing the amount of physical machines only when virtual machines are first placed in the physical machines, but cannot actively cope with a change in an operation of virtual machines, namely, a change such as cessation, deletion, or the like, of virtual machines, degrading power saving efficiency

Meanwhile, the QoS-based placement method places a virtual machine desired by a user in a physical machine having a large amount of available resources to guarantee performance of the virtual machine. However, in a case in which operated virtual machines are increasing in number, the amount of operated physical machines is also increased to incur high energy cost.

Further, the existing virtual machine placement methods fall short of consideration with respect to placement of a plurality of nodes. For example, when a user generates and installs a plurality of virtual machines by bulk at one time, the existing methods places the virtual machines in physical machines without consideration of a usage purpose of the virtual machines.

### SUMMARY OF THE INVENTION

The present invention has been made in an effort to provide a system and method for virtual machine placement and management having advantages of actively coping with a change and selecting a physical machine in consideration of a usage purpose of a virtual machine in an operation of a virtual machine in a cluster node system. An exemplary embodiment of the present invention provides a method for placing and managing virtual machines in a system for virtual machine placement and management. The method may include: monitoring information regarding states of physical machines and virtual machines operated in a group; and relocating the virtual machines operated in the group according to the information regarding states of the physical machines operated in the group and a placement policy of the virtual machines.

The state information may include resource state information.

The relating may include: selecting a virtual machine to be relocated; and selecting a physical machine to which the virtual machine is to be relocated from within the group without increasing the amount of physical machines operated in the group when the placement policy of the virtual machine is a power-based policy.

The method may further include: determining a virtual machine to migrate according to the information regarding states of the physical machines and the virtual machine operated in the group; selecting a physical machine to which the virtual machine is to migrate; and migrating the virtual machine to migrate to the selected physical machine.

The selecting may include: selecting a physical machine to which the virtual machine is to migrate, from within a subgroup in which the virtual machine to migrate is operated; and when a physical machine to which the virtual machine is to migrate does not exist in the subgroup in which the virtual machine to migrate is operated, selecting a physical machine to which the virtual machine is to migrate from within a different subgroup within the same group.

The subgroup in which the virtual machine to migrate is operated and the different subgroup may form the same group.

The determining may include determining a virtual machine having a fault as a virtual machine to migrate according to the information regarding states of virtual machines.

The method may further include: receiving a request for generating a virtual machine from a user; selecting a physical machine for the virtual machine to be generated according to a usage purpose of the virtual machine; and generating the virtual machine in the selected physical machine.

The selecting may include: determining a placement policy of the virtual machine to be generated; selecting a group in which the virtual machine is to be placed according to the determined placement policy and the usage purpose of the virtual machine; selecting a subgroup within the group in which the virtual machine is to be placed; and selecting a physical machine in which the virtual machine to be generated is to be placed from within the selected subgroup.

The selecting of a physical machine may include, when the number of virtual machines to be generated is plural, selecting a physical machine in which the plurality of virtual machines are to be placed from within the same group.

Another embodiment of the present invention provides a system for placing and managing virtual machines in a cluster node system. The system may include a virtual machine placement policy manager, a virtual machine placement manager, a global virtual machine group manager, and at least one local virtual machine group manager.

The virtual machine placement policy manager may determine a placement policy of a virtual machine to be generated according to a virtual machine generation request from a user. The virtual machine placement manager may select a group in which the virtual machine is to be placed according to the determined placement policy and a purpose of generating the virtual machine. The global virtual machine group manager may manage physical machines and virtual machines operated in the group, and select a subgroup of the group in which the virtual machine is to be placed. The at least one local virtual machine group manager may manage physical machines and virtual machines operated in at least one subgroup of the group. The local virtual machine group manager, which manages the selected subgroup among the at least one local virtual machine group manager, may generate the virtual machine, select a physical machine in which the virtual machine is to be placed, and place the virtual machine.

The at least one local virtual machine group manager may relocate an operated virtual machine according to information regarding resource states of physical machines operated in each subgroup.

The system may further include a virtual machine migration manager. The virtual machine migration manager may determine migration of a virtual machine according to information regarding states of the physical machines and virtual machines operated in the at least one subgroup.

The global virtual machine group manager or the at least one local virtual machine group manager may migrate the virtual machine.

The local virtual machine group manager, which manages subgroups in which the virtual machine to migrate is operated, may select a physical machine to which the virtual machine is to migrate from within a corresponding subgroup.

When a physical machine to which the virtual machine is to migrate does not exist within the corresponding subgroup, the global virtual machine group manager may select a physical machine to which the virtual machine is to migrate from within a different subgroup.

The virtual machine migration manager may determine migration of the virtual machine when the amount of operated physical machines is available to be reduced.

The virtual machine migration manager may determine a virtual machine having a fault as the virtual machine to migrate.

When the number of virtual machines to be generated is plural, the virtual machine placement manager may select the same group as a group in which the plurality of virtual machines are to be placed.

### BRIEF DESCRIPTION OF THE DRAWINGS

FIG. 1 is a view illustrating a system for virtual machine placement and management according to an embodiment of the present invention.

FIG. 2 is a view illustrating a detailed configuration of a cluster node system illustrated in FIG. 1.

FIG. 3 is a view schematically illustrating a method for virtual machine placement and management in the cluster node system illustrated in FIG. 2.

FIG. 4 is a view illustrating a method of relocating a virtual machine according to an embodiment of the present invention.

FIG. 5 is a view illustrating a method of generating a virtual machine first in a system for virtual machine placement and management according to an embodiment of the present invention.

FIG. 6 is a view illustrating a method of placing and managing a virtual machine detected to have an error in the system for virtual machine placement and management according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a system and method for virtual machine placement and management according to an embodiment of the present invention will be described in detail.

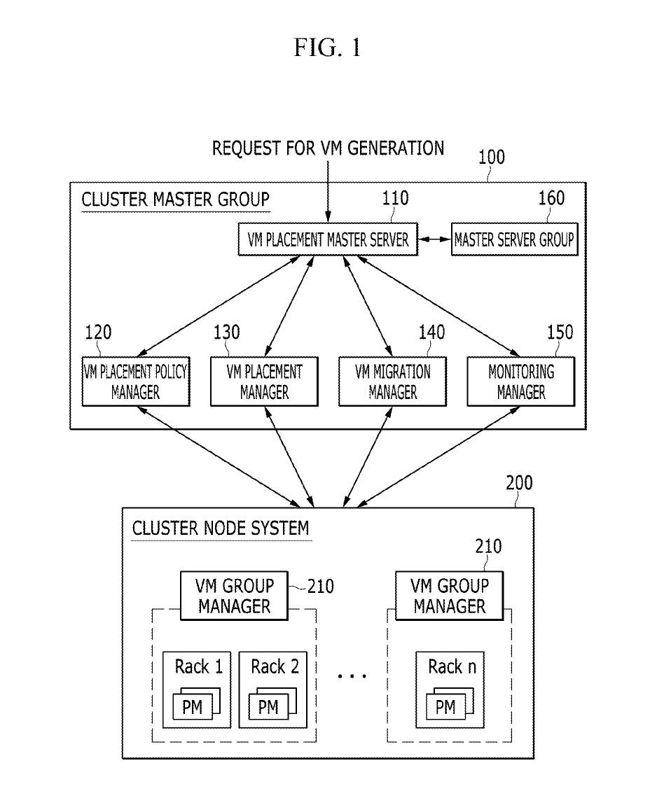

FIG. 1 is a view illustrating a system for a virtual machine placement and management according to an embodiment of the present invention.

Referring to FIG. 1, the system for a virtual machine placement and management includes a cluster master group 100 and a cluster node system 200.

The cluster master group 100 includes a virtual machine (VM) placement master server 110, a VM placement polity manager 120 a VM placement manager 130, a VM migration manager 140, and a monitoring manager 150. The cluster master group 100 may further include a master server group 160.

The cluster node system 200 includes a plurality of racks rack 1, . . . , rack n and a plurality of VM group managers 210

In the cluster master group 100, when the VM placement master server 110 receives a VM generation request from a user, the VM placement master server 110 checks VM generation-related information, a VM placement policy, and information regarding availability of VM migration, and delivers the VM generation-related information, the VM placement policy, and the information regarding availability of VM migration to the VM placement policy manager 120. The VM generation-related information may include VM specification information, and the VM specification information may include CPU capacity, memory capacity, disk capacity, network capacity, and the like. The VM placement policy may include a power-based policy, a QoS-based policy, and another placement policy.

The VM placement policy manager 120 performs a function of determining a VM placement policy. The VM placement policy manager 120 may determine a VM placement policy according to the VM placement policy of the user included in the VM generation request from the user. In a case in which a VM placement policy is not included in the VM generation request, the VM placement policy manager 120 may determine a VM placement policy based on a pre-set placement policy.

The VM placement manager 130 selects an optimal group in which a VM is to be installed according to the VM specification information and the VM placement policy included in the VM generation request, and requests VM generation from a corresponding VM group manager 210.

The VM migration manager 140 determines whether a VM is available for movement and placement, and when a VM movement event occurs, the VM migration manager 140 determines whether a VM is actually movable according to PM or VM state information and information regarding operation of a cluster node system, and the like, and delivers the same to the corresponding VM group manager 210. Here, the PM or VM state information may include information regarding a fault of a PM or a VM, and information (CPU information, memory information, disk usage information, network information, and the like) regarding usage resource of a VM operated in each PM. The information regarding operation of the cluster node system may include monitoring information managed by the monitoring manager 150.

The VM migration manager 140 determines migration of only a migration-available VM and delivers migration execution to the corresponding VM group manager 210, and the actual corresponding VM group manager 210 performs migration.

Also, when a manager wants to perform particular VM migration for a particular reason, the manager may request the particular VM migration from the VM placement master server 110, and the VM placement master server 110 requests the particular VM migration from the VM migration manager 140. The VM migration manager 140 searches the VM group manager 210 to which a VM to migrate belongs, and delivers a migration command so that the corresponding VM group manager 210 can finally perform migration.

The monitoring manager 150 monitors and manages information regarding a PM, information regarding basic specification of the PM, and basic information regarding a rack, a switch, or the like, and may include an identifier given to a rack, the number of PMs included in the rack, a rack identifier of each PM, switch information, an identifier of a connected switch, and the like. The information regarding basic specifications of a PM may include physical specification information such as a CPU, a memory, a network, a disk, or the like, and basic information regarding a rack, a switch, and the like, and may include an identifier given to a rack, the number of PMs included in a rack, a rack identifier of each PM, switch information, an identifier of a connected switch, and the like.

The master server group 160 performs a recovery function when a fault occurs in the VM placement master server 110, the VM placement policy manager 120, the VM placement manager 130, the VM migration manager 140, and the monitoring manager 150.

In the cluster node system 200, a plurality of racks rack 1, . . . , rack n include at least one PM in which a VM is to be installed and operated. The plurality of racks rack 1, . . . , rack n may be divided into a plurality of groups. That is, one or more racks may form a group. For example, racks rack 1 and rack 2 may form a group, and a rack n may form a group. Also, each group may be divided into a plurality of subgroups.

Each VM group manager 210 may include a local VM group manager (not shown) and a global VM group manager (not shown). The global VM group manager is a master server that manages a VM operated in a group, and the local VM group manager is a master server that manages a VM operated in a subgroup.

The VM placement master server 110, the VM placement policy manager 120, the VM placement manager 130, the VM migration manager 140, and the monitoring manager 150 of the cluster master group 110 may be separately managed.

Each VM group manager 210 may be one of a general node of a corresponding group, and may be configured separately.

The cluster node system 200 may further include a backup server (not shown) to support availability of each VM group manager 210.

Also, in a single group, a local VM group manager or a global VM group manager may be separately configured, and in a small group, a global VM group manager and a local VM manager may not be separately configured.

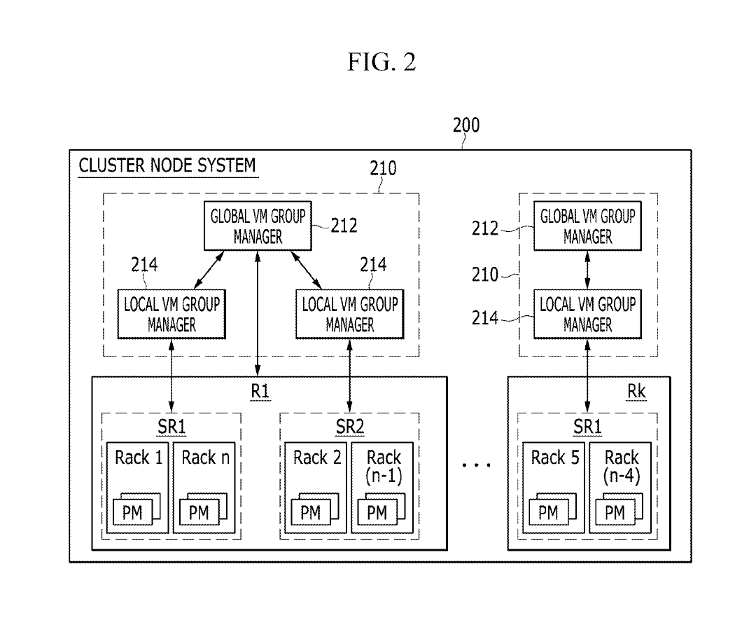

FIG. 2 is a view illustrating a detailed configuration of a cluster node system illustrated in FIG. 1.

Referring to FIG. 2, in the cluster node system 200, a plurality of racks rack 1, . . . , rack n may be divided into at least one group R1, . . . , Rk so as to be operated. Also, the groups R1, . . . , Rk may be divided into at least one subgroup so as to be operated.

For example, as illustrated in FIG. 2, racks [rack1, rack 2, rack (n−1), rack n] may form a group R1, and racks [rack 5, rack (n−4)] may from a group Rk. Here, the group R1 may include two subgroups SR1 and SR2. The subgroup SR1 includes racks [rack1, rack n], and the subgroup SR2 includes racks [rack 2, rack n−1]. Also, racks [rack 5, rack (n−4)] may form a group Rk. The group Rk may include a single subgroup R1.

When a single rack has a large size, the rack may be divided into several subgroups or groups so as to be operated.

A plurality of racks rack 1, . . . , rack n may be divided into groups by a manager. For example, the manager may divide a plurality of racks rack 1, . . . , rack n into groups and subgroups upon determination on the basis of information regarding specifications of PMs, disposition, a size of a PM, an anticipated VM generation size, and various other information required for system configuration.

Alternatively, the plurality of racks rack 1, . . . , rack n may be divided into groups and subgroups according to a reference determined by the cluster node system 200.

In this manner, in the case in which a group is divided into at least one subgroup and operated, the VM group manager 210 managing the corresponding group may include a global VM group manager 212 and at least one local VM group manager 214.

Meanwhile, when a size of a group such as the group Rk is not large, the global VM group manager 212 and the local VM group manager 214 are not configured, and the corresponding VM group manager 210 may perform an integrated function of the global VM group manager 212 and the local VM group manager 214.

The local VM group manager 214 manages a corresponding subgroup. In particular, the local VM group manager 214 manages operations such as generation, cessation, termination, migration, and the like, of a VM in the corresponding subgroup, and collect monitoring information such as information regarding states of PMs and VMs, specification information, and the like, and delivers the same to the global VM group management 212 of the corresponding group.

The global VM group manager 212 collects the monitoring information from the local VM group manager 214, reduces an amount of the monitoring information, and delivers the reduced amount of monitoring information to the monitoring manager 150 of the cluster master group 100. The global VM group manager 212 handles operation and management such as generation, cessation, termination, migration, and the like, of a VM.

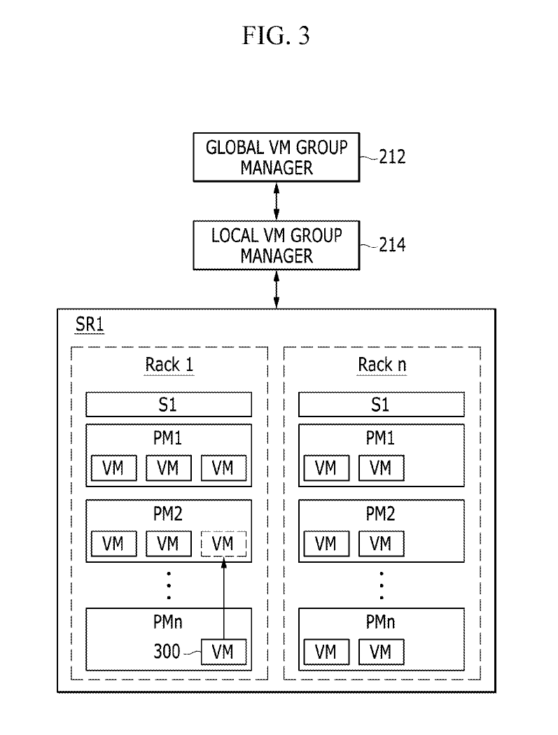

FIG. 3 is a view schematically illustrating a method for virtual machine placement and management in the cluster node system illustrated in FIG. 2.

In FIG. 3, only a single subgroup SR1 of a single group R1 is illustrated, and it is assumed that the subgroup SR1 includes PMs having a similar specification, a similar state, or a similar network condition.

Referring to FIG. 3, racks Rack 1 and Rack n include a switch S1 and n number of PMs, i.e., PM1 to PMn, for supporting a network, respectively.

At least one VM may be operated in the PM1 to PMn. VMs are placed in appropriate PMs according to a VM placement policy.

For example, when a VM is operated in the PM1, and when a particular situation arises, the VM may migrate to a different PM. The local VM group manager 214 monitors information regarding states of the VMs and states of the PMs, and delivers the information regarding the states of the VMs and PMs to the global VM group manager 212. The global VM group manager 212 delivers the information regarding states of the VM and PM to the monitoring manager 150. The VM migration manager 140 determines whether to move a VM according to the information regarding states of the VMs and the PMs.

A migration event of a VM according to whether the VM moves is performed by the local VM group manager 214 or the global VM group manager 212. In particular, in a case in which the VM placement policy is a power-based policy, VM migrations may frequently occur. If the amount of operated PMs is reduced, the VM migration manager 140 may migrate a particular VM to a different PM. For example, the VM migration manager 140 may determine migration of a VM 300 operated in the PMn to reduce the amount of PMs.

When migration of the VM 300 is determined by the VM migration manager 140, the local VM group manager 214 checks information regarding available resource states of the PMs operated in the racks Rack 1 and Rack N of the same subgroup. For example, when the PM2 of the rack Rack 1 is an available PM to which the VM 300 may migrate, the local VM group manager 214 selects the PM2 as a PM to which the VM 300 is to migrate, and migrates the VM 300 to the PM2.

Thereafter, when a VM operated in the PMn does not exist, power of the PMn is stopped to save energy. In this manner, the local VM group manager 214 periodically checks information regarding states of VMs, and the like, and migrates a VM to an available PM, thus minimizing the amount of PMs to save energy.

Meanwhile, if a migration-available PM does not exist in the subgroup, a migration-available PM is selected from within a higher group, and the selection of the migration-available PM within a higher group is performed by the global VM group manager 212. That is, when a migration-available PM does not exist within the subgroup, the global VM group manager 212 may select a migration-available PM from a different subgroup of the same group.

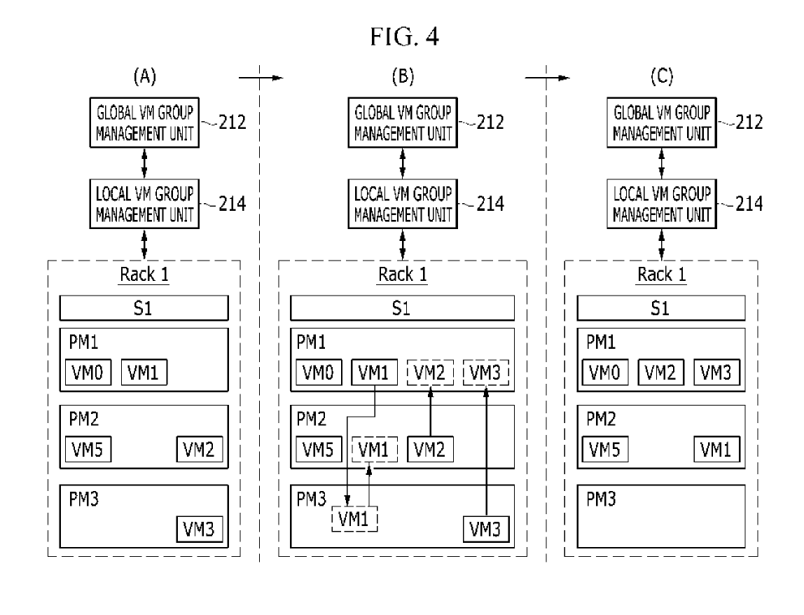

FIG. 4 is a view illustrating a method of relocating a virtual machine according to an embodiment of the present invention. In FIG. 4, a process of relocating operated VMs in order to save energy in the case in which a VM placement policy is power-based policy is shown.

As illustrated in (A) of FIG. 4, when VM0 and VM1 are operated in the PM1, VM5 and VM2 are operated in the PM2, and VM3 is operated in the PM3, the local VM group manager 214 monitors information regarding states of the PM1, PM2, and PM3, and information regarding states of the VM0, VM1, VM2, VM3, and VM5, and when a situation VM relocation is available occurs, the local VM group manager 214 determines and performs VM relocation.

For example, it is assumed that the VM0 and VM1 use CPU capacity and memory capacity, typical resources among resources of the PM1, and in this case, the VM0 and VM1 use about 90% of the CPU resources of the PM1 so the CPU has about 10% available resources, and the VM0 and VM1 use about 50% of the memory of the PM1 so the memory of the PM1 has 50% available resources. In this case, the CPU of the PM1 is almost all used and there are no wasted resources, but in the case of the memory of PM1, 50% of the resources are wasted. Thus, it can be said that the resources of PM1 are not effectively used.

Also, it is assumed that the memory of PM2 has about 10% available resources, and the CPU of the PM2 has about 60% available resources. Then, the memory of the PM2 is almost all used so there are no wasted resources, but in the case of the CPU of the PM2, about 60% of the resources are wasted.

Thus, when about 50% of the resources of the memory of the PM1 remain to be wasted, and about 60% of the resources of the CPU of the PM2 remain to be wasted, it cannot be said that resources of all PMs within the rack Rack 1 are effectively used. In particular, in case of a power-based scheme, the amount of operated PMs may be increased due to ineffective PM utilization, and thus energy may be wasted. In order to solve this problem, the local VM group manager 214 may relocate operated VMs to reduce a waste of resources of the PMs.

The local VM group manager 214 monitors resource states of PMs of a subgroup, and when resource waste is severe, the local VM group manager 214 determines relocation of VMs and generates a relocation event. The local VM group manager 214 may determine a list of relocation-available VMs, and relocate VMs to be relocated in an optimal PM.

As illustrated in (A) of FIG. 4, when the VM0 and VM1 are operated in the PM1, the VM5 and VM2 are operated in the PM2, and the VM3 is operated in the PM3, the local VM group manager 214 may determine relocation of VMs on the basis of information regarding resource states of the PM1, PM2, and PM3.

As illustrated in (B) of FIG. 4, the local VM group management unit 214 may move the VM1 of the PM1, VM2 of the PM2, and VM3 of the PM3, thereby relocating them. That is, since the available resources of the PM1 and PM2 are not sufficient, the local VM group management unit 214 can't be moved the VM3 to the PM1 or the PM2 directly. Thus, the local VM group management unit 214 may determine relocation of the VM1 and VM2 to ensure available resources. Since the available resources of the PM2 are not sufficient, the local VM group management unit 214 may move the VM1 to the PM3 having sufficient available resources, and then may move the VM2 to the PM1. Next, the local VM group management unit 214 may move the VM1 to the PM2.

As a result, if available resources of the PM1 are not sufficient, the local VM group management unit 214 may move the VM3 to PM1.

In this manner, the result of relocation of the VMs is shown in (C) of FIG. 4. Referring to (C) of FIG. 4, PM1 and PM2 are actually operated PMs and the PM3 does not have any operated VM, and thus power of the PM3 can be stopped. In this manner, wasted resources of PMs are reduced and the amount of operating PMs is reduced through relocation of VMs, saving energy.

Based on the VM relocation policy, a movement between subgroups takes priority, and when there is no PM to which a VM is movable within a subgroup, an available PM may be selected from a higher group. This may be performed by the global VM group manager 212. Here, a selection range of PMs may be limited according to a manager selection, and in this case, a selection range of PMs may be limited to a group using the same policy according to the VM placement policy. That is, VM relocation may be performed among subgroups using a power-based placement policy.

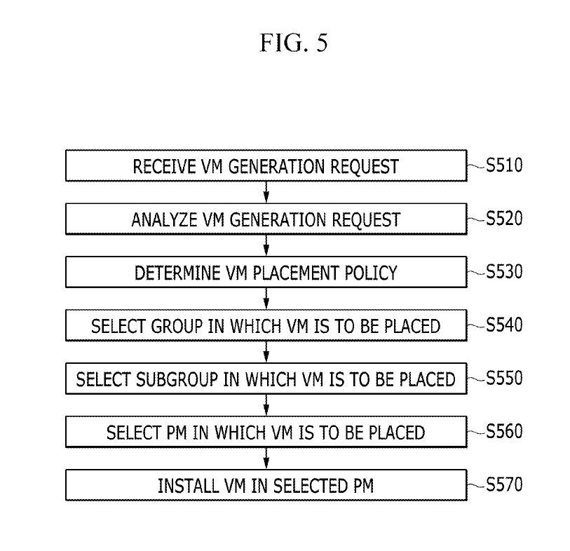

FIG. 5 is a view illustrating a method of generating a virtual machine first in a system for virtual machine placement and management according to an embodiment of the present invention.

Referring to FIG. 5, the VM placement master server 110 receives a VM generation request including information regarding specifications of VMs, the number of VMs desired to be generated, information regarding whether a VM is available to migrate, a VM placement policy, and the like, from a user (S510).

The VM placement mater server 110 analyzes the VM generation request from the user (S520), and delivers the VM generation request information to the VM placement policy manager 120.

The VM placement policy manager 120 determines a VM placement policy according to the VM placement policy included in the VM generation request (S530). When a VM placement policy is not included in the VM generation request, the VM placement policy manager 120 may determine a VM placement policy based on a placement policy previously set therein.

The VM placement manager 130 selects an optimal group in which a VM is to be placed according to the determined VM placement policy (S540). When a plurality of VMs are generated by bulk, the VM placement manager 130 preferentially selects the same group, whereby the VMs generated by bulk can be managed in the same group, facilitating performance and management. In particular, in a case in which the VM placement policy is a power-based policy and VMs are generated by bulk, the VM placement manager 130 checks an operational state of all groups, searches a group capable of accommodating a plurality of VMs from among power-based groups, and preferentially selects a group having the smallest amount of PMs to be operated among groups capable of accommodating a plurality of VMs. That is, the VM placement manager 130 preferentially uses a PM which can afford to use resource, among operated PMs, thus reducing wasted PM resources and the amount of operated PMs. Also, in a case in which the VM placement policy is generated as a QoS-based policy, the VM placement manager 130 may select a group starting from a group having the greatest amount of available resources of PMs.

Also, in a case in which the user requests generation of a plurality of VMs and a generation purpose of the VMs is to perform a great deal of data communications between or among VMs, the VM placement manager 130 may preferentially place the plurality of VMs requested to be generated in the same group, thus allowing for smooth communication between or among VMs.

The global VM group manager 212 selects a PM in which a VM is to be placed from within a group selected by the VM placement manager 130 (S560), and installs and operates the VM in the selected PM (S570).

In this case, in case of a large group, the global VM group manager 212 may select an optimal subgroup in which a VM is to be placed from a group selected by the VM placement manager 130 (S550), and delivers the VM generation request information to the VM group manager 214 that manages the selected subgroup. Then, the local VM group manager 214 may select a PM in which the VM is to be placed (S560), and installs and operates the VM in the selected PM (S570).

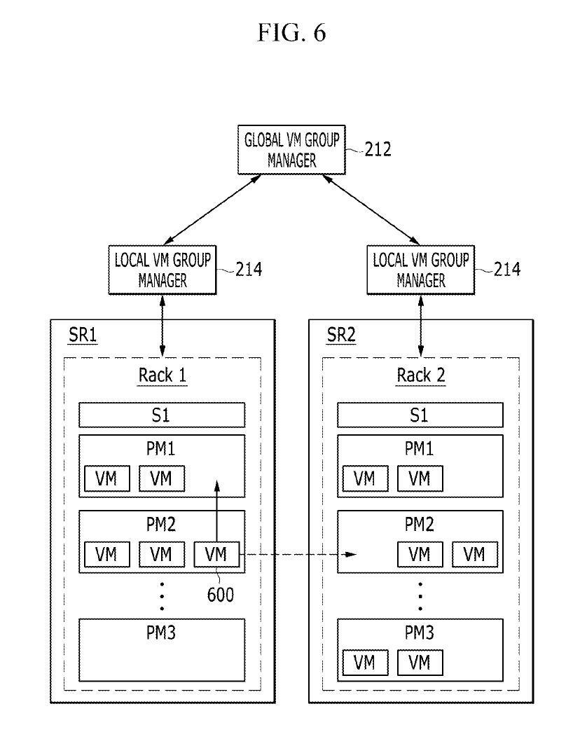

FIG. 6 is a view illustrating a method of placing and managing a virtual machine detected to have an error in the system for virtual machine placement and management according to an embodiment of the present invention. In FIG. 6, a recovery method in a case in which a VM has a fault when a VM placement policy is a power-based policy is illustrated. Also, in FIG. 6, a single rack Rack 1 of the subgroup SR1 and a single rack Rack 2 of the subgroup SR2 are illustrated. Here, the subgroups SR1 and SR2 are subgroups of the same group R1.

Referring to FIG. 6, the global VM group manager 212 and the local VM group manager 214 monitor information regarding states of VMs, and deliver the VM state information to the monitoring manager 150. When a fault of a VM is sensed on the basis of the information regarding states of VMs and PMs, the VM migration manager 140 determines migration of the VM. Here, the global VM group manager 212 or the local VM group manager 214 may sense a fault of the VM, and when a fault of the VM is sensed, the global VM group manager 212 or the local VM group manager 214 may determine migration of the corresponding VM. That is, the determination of migration due to a fault may be performed by a component that has first sensed the fault. As illustrated in FIG. 6, when a VM 600 operated in PM2 of rack Rack1 has a fault, migration of the VM 600 is determined.

When migration of the VM 600 is determined, a migration operation is performed by the local VM group manager 214.

The local VM group manager 214 selects a PM to which the VM 600 having a fault is to migrate. First, the local VM group manager 214 selects a PM to which the VM 600 is to migrate without increasing the amount of PMs operated in the same subgroup SR1. For example, when available PMs in the subgroup SR1 are PM1 and PM3, the local VM group manager 214 may select the PM1 as a PM to which the VM 600 is to migrate. That is, if the VM 600 migrates to the PM3, the amount of operated PMs is increased to increase operating power. Thus, in order to reduce an energy increase, the local VM group manager 214 may select the PM1 as a PM to which the VM 600 is to migrate.

If an only available PM is the PM3, the local VM group manager 214 may request PM selection from the global VM group manager 212.

The global VM group manager 212 may select an available PM within a different subgroup SR2 of the same group R1 to which the subgroup SR1 belongs. If the PM2 of the subgroup SR2 is available, the global VM group manager 212 may select the PM2 as a PM to which the VM 600 is to migrate, and migrates the VM 600 to the PM2.

In this manner, the amount of operated PMs can be minimized to reduce energy consumption, and recovery of a VM having a fault can be quickly supported to increase availability of the VM.

Meanwhile, when the VM placement policy is a QoS-based policy, the local VM group manager 214, which manages the subgroup SR1, preferentially selects a PM having sufficient available resources as a PM to which the VM 600 having a fault is to migrate. For example, when it is assumed that PM1 and PM2 in which VMs are operated exist and the PM1 has 60% remaining CPU capacity and 70% memory capacity as available resources and the PM2 has 50% remaining CPU and memory capacity, respectively, the VM 600 having a fault may migrate to either PM1 or PM2, but migration to the PM1 can use more resources and guarantee maximum performance, so the local VM group manager 214 selects the PM1 as a PM to which the VM 600 having a fault is to migrate.

If available resources of a PM are not sufficient, the PM3 in which a VM is not operated may be selected as a PM to which the VM 600 is to migrate. In a case in which a PM to which the VM is to migrate does not exist in the same subgroup SR1, an available PM may be selected from a different subgroup.

Meanwhile, when a PM, rather than a VM, has a fault, the local VM group manager 214, which manages a subgroup in which the corresponding PM is operated, may migrate all the VMs operated in the PM having a fault to a different PM. The PM migration method may be performed in a manner similar to that of the VM migration method.

According to embodiments of the present invention, when wasted resources of physical machines are generated due to a change in operated virtual machines, migration or relocation of virtual machines is performed, obtaining an effect of increasing energy efficiency while maintaining performance. Further, when a user requests a plurality of virtual machines, the virtual machines are placed in consideration of a usage purpose of the virtual machines, a network condition, or disposition of physical machines, thereby effectively operating virtual machines.

The embodiments of the present invention may not necessarily be implemented only through the foregoing devices and/or methods, but may also be implemented through a program for realizing functions corresponding to the configurations of the embodiments of the present invention, a recording medium including the program, or the like. Such an implementation may be easily conducted by a person skilled in the art to which the present invention pertains from the foregoing description of embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for placing and managing virtual machines in a system for a virtual machine placement and management, the method comprising:
monitoring information regarding states of physical machines and virtual machines operated in a group; and
relocating the virtual machines operated in the group according to the information regarding states of the physical machines operated in the group and a placement policy of the virtual machines.

2. The method of claim 1, wherein the state information includes resource state information.

3. The method of claim 1, wherein the relocating comprises:
selecting a virtual machine to be relocated; and
selecting a physical machine to which the virtual machine is to be relocated from within the group without increasing the amount of physical machines operated in the group when the placement policy of the virtual machine is a power-based policy.

4. The method of claim 1, further comprising:
determining a virtual machine to migrate according to the information regarding states of the physical machines and the virtual machine operated in the group;
selecting a physical machine to which the virtual machine is to migrate; and
migrating the virtual machine to migrate to the selected physical machine.

5. The method of claim 4, wherein the selecting comprises:
selecting a physical machine to which the virtual machine to migrate, from within a subgroup in which the virtual machine to migrate is operated; and
when a physical machine to which the virtual machine is to migrate does not exist in the subgroup in which the virtual machine to migrate is operated, selecting a physical machine to which the virtual machine is to migrate from within a different subgroup within the same group.

6. The method of claim 5, wherein the subgroup in which the virtual machine to migrate is operated and the different subgroup form the same group.

7. The method of claim 4, wherein the determining comprises determining a virtual machine having a fault as a virtual machine to migrate according to the information regarding states of virtual machines.

8. The method of claim 1, further comprising:
receiving a request for generating a virtual machine from a user;
selecting a physical machine for the virtual machine to be generated according to a usage purpose of the virtual machine; and
generating the virtual machine in the selected physical machine.

9. The method of claim 8, wherein the selecting comprises:
determining a placement policy of the virtual machine to be generated;
selecting a group in which the virtual machine is to be placed according to the determined placement policy and the usage purpose of the virtual machine;
selecting a subgroup within the group in which the virtual machine is to be placed; and
selecting a physical machine in which the virtual machine to be generated is to be placed from within the selected subgroup.

10. The method of claim 9, wherein the selecting of a physical machine comprises,
when the number of virtual machines to be generated is plural, selecting a physical machine in which the plurality of virtual machines are to be placed from within the same group.

11. A system for placing and managing virtual machines in a cluster node system, the system comprising:
a virtual machine placement policy manager configured to determine a placement policy of a virtual machine to be generated according to a virtual machine generation request from a user;
a virtual machine placement manager configured to select a group in which the virtual machine is to be placed according to the determined placement policy and a purpose of generating the virtual machine;
a global virtual machine group manager configured to manage physical machines and virtual machines operated in the group, and select a subgroup of the group in which the virtual machine is to be placed; and
at least one local virtual machine group manager configured to manage physical machines and virtual machines operated in at least one subgroup of the group,
wherein the local virtual machine group manager, which manages the selected subgroup among the at least one local virtual machine group manager, generates the virtual machine, selects a physical machine in which the virtual machine is to be placed, and places the virtual machine.

12. The system of claim 11, wherein the at least one local virtual machine group manager relocates an operated virtual machine according to information regarding resource states of operated physical machines in each subgroup.

13. The system of claim 12, wherein the at least one local virtual machine group manager relocates the operated virtual machines with an aim of a reduction in the amount of operated physical machines in each subgroup.

14. The system of claim 11, further comprising
a virtual machine migration manager configured to determine migration of a virtual machine according to information regarding states of physical machines and virtual machines operated in the at least one subgroup,
wherein the global virtual machine group manager or the at least one local virtual machine group manager migrates the virtual machine.

15. The system of claim 14, wherein the local virtual machine group manager, which manages subgroups in which the virtual machine to migrate is operated, selects a physical machine to which the virtual machine is to migrate from within a corresponding subgroup.

16. The system of claim 15, wherein when a physical machine to which the virtual machine is to migrate does not exist within the corresponding subgroup, the global virtual machine group manager selects a physical machine to which the virtual machine is to migrate from within a different subgroup.

17. The system of claim 14, wherein the virtual machine migration manager determines migration of the virtual machine when the amount of operated physical machines is available to be reduced.

18. The system of claim 14, wherein the virtual machine migration manager determines a virtual machine having a fault as the virtual machine to migrate.

19. The system of claim 11, wherein when the number of virtual machines to be generated is plural, the virtual machine placement manager selects the same group as a group in which the plurality of virtual machines are to be placed.

20. The system of claim 11, wherein when the placement policy is a QoS-based policy, the virtual machine placement manager selects a group having a great amount of available resources of physical machines.
